(19) United States
(12) Patent Application Publication
(10) Pub. No.: US 2012/0265685 A1
(43) Pub. Date: Oct. 18, 2012

(54) System and Method for Physical-World Based Dynamic Contactless Data Emulation in a Portable Communication Device

(75) Inventors: David Brudnicki, Duvall, WA (US); Kaushik Roy, Foster City, CA (US); Michael Craft, Carlsbad, CA (US); Hans Reisgies, San Jose, CA (US); Andrew Weinstein, San Francisco, CA (US)

(73) Assignee: Sequent Software Inc., Redwood City, CA (US)

(21) Appl. No.: 13/447,495

(22) Filed: Apr. 16, 2012

Related U.S. Application Data
(63) Continuation-in-part of application No. 13/279,206, filed on Oct. 21, 2011.
Application No. 13/279,206 is a continuation-in-part of application No. 13/284,693, filed on Oct. 28, 2011.
(60) Provisional application No. 61/414,847, filed on Nov. 17, 2010.
(60) Provisional application No. 61/414,849, filed on Nov. 17, 2010.

(51) Int. Cl. G06Q 20/40

(52) U.S. Cl. 705/44

(57) ABSTRACT

This invention involves, in part, a system for automatically selecting a credential among a plurality of credentials on a portable communication device based on a geo-location of the portable communication device and based on a user preference, for use in an electronic wallet transaction. The system includes a geo-location device configured to detect the geo-location of the portable communication device; a location identification service unit configured to be activated by a pre-determined user input, and configured to determine a merchant where the portable communication device is most likely to be located based on said geo-location; means for storing preferences corresponding to the plurality of credentials; and means for automatically determining which of the plurality of credentials to use for the electronic wallet transaction based on the preferences.

This application is a continuation-in-part of U.S. patent application Ser. No. 13/279,206, filed on Oct. 21, 2011, which application claims priority from U.S. Provisional Patent Application No. 61/414,847, filed on Nov. 17, 2010 and U.S. Provisional Patent Application No. 61/414,849, filed on Nov. 17, 2010. This application is also a continuation-in-part of U.S. patent application Ser. No. 13/284,863, filed on Oct. 28, 2011. All of these applications are incorporated by reference in their entirety.

### TECHNICAL FIELD

The present invention relates generally to the use of secure data to complete a wireless transaction, and more particularly to a system and method for dynamically adjusting the contactless data emulation produced by a portable communication device based on physical world geo-location information.

### BACKGROUND

Wireless transactions using RFID-based proximity cards are fairly common place. For instance, many workers use RFID keycards to gain access to their workplace and drivers use RFID passes to pay tolls at highway speeds. RFID, which stands for radio-frequency identification, uses electromagnetic waves to exchange data between a terminal and some object for the purpose of identification. More recently, companies have been trying to use RFIDs supported by cellular telephones to implement an electronic payment product (i.e. credit and/or debit card). However, basic RFID technology raises a number of security concerns that have prompted modifications of the basic technology. Still, widespread adoption of RFID as a mechanism for electronic payments has been slow.

Near Field Communication (NFC) is another technology that uses electromagnetic waves to exchange data. NFC waves are only transmitted over a short-range (on the order of a few inches) and at high-frequencies. NFC devices are already being used to make payments at point of sale devices. NFC is an open standard (see, e.g. ISO/IEC 18092) specifying modulation schemes, coding, transfer speeds and RF interface. There has been wider adoption of NFC as a communication platform because it provides better security for financial transactions and access control. Other short distance communication protocols are known and may gain acceptance for use in supporting financial transactions and access control.

Regardless of the wireless communication protocol selected there are bound to be operation errors both within the devices the protocol is implemented on (called “wireless wallets” in the present specification) as well as within communications between the wireless wallet and local host devices (e.g. point of sale terminals, keycard access control terminals), within the local host devices; within any server-side equipment that must interact with the local host devices (e.g. for confirmation or approval); and within communications between the wireless wallet, its mobile network and beyond. For instance, a consumer may have trouble completing a purchase using the “credit card” embedded in his smartphone in a big-box retail store at the point of sale because of one or more problems with (1) the NFC connection between the consumer's phone and the POS; (2) the secure data is corrupt on the consumer's smartphone; (3) the consumer's electronic wallet account has been disabled by the card issuer; (4) the POS device has outdated NFC communication software; etc.

A problem arises in that no single company is presently responsible for coordinating the troubleshooting of failed electronic wallet transactions. As such, a consumer may have a difficult time determining which—if any—of the foregoing potential problems is preventing the desired electronic wallet transaction. Thus, the consumer may stop using the electronic wallet or may not be able to complete a transaction with that particular retailer leading the consumer to try to consummate a similar transaction at a competitor.

One problem that may prevent successful completion of a transaction is due the myriad of communications protocols associated with the various different point of sale terminals available. So, for instance, the protocol necessary to successfully communicate wirelessly with an IBM point of sale terminal may be very different from the protocol necessary to communication with an NCR terminal. Accordingly, it is an object of the present invention to provide a system and method for using geo-location data (where available) to try to predetermine the likely point of sale terminal device present in the retail establishment co-located with the portable communication device.

A related problem arises in that diagnostic software that can facilitate diagnosis of the problem has not been developed for deployment and use on smartphone or similar devices.

Accordingly, the present invention seeks to provide one or more solutions to the foregoing problems and related problems as would be understood by those of ordinary skill in the art having the present specification before them. These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### SUMMARY OF THE INVENTION

This invention involves, in part, a system for automatically selecting a credential among a plurality of credentials on a portable communication device based on a geo-location of the portable communication device and based on a user preference, for use in an electronic wallet transaction. The system includes a geo-location device configured to detect the geo-location of the portable communication device; a location identification service unit configured to be activated by a pre-determined user input, and configured to determine a merchant where the portable communication device is most likely to be located based on said geo-location; means for storing preferences corresponding to the plurality of credentials; and means for automatically determining which of the plurality of credentials to use for the electronic wallet transaction based on the preferences.

In one embodiment, the invention relates to a system for automatically emulating a preferred electronic credential from among a plurality of electronic credentials. The system is associated with a portable communication device having a geo-location identification service configured to detect a current geo-location of the portable communication device. The system comprises an interface for obtaining predetermined user preferences for the plurality of electronic credentials wherein at least some of the preferences relate to the geo-location of the portable communication device; a processor configured to compare the current geo-location of the portable communication device with each of the predetermined user preferences and to select a preferred electronic credential from the plurality of electronic credentials; and a secure element having a proximity payment system environment (PPSE), wherein each of the plurality of credentials are stored in the PPSE, wherein the processor further reorganizes the plurality of credentials such that the preferred electronic credential is placed in the PPSE to be emulated during a series of transactions.

The interface provides the ability to prioritize the predetermined user preferences. The interface may also provide the ability to select between two or more electronic credentials from the plurality of electronic credentials when a preference conflict arises. In addition, the interface displays one or more coupons, the processor further facilitating selection of one or more of the coupons and reorganizing the plurality of credentials such that the electronic credential associated with each selected one of the one or more coupons is placed in the PPSE to be emulated during a series of transactions.

The portable communication device may further include a real-time service that indicates a current date and time, the processor further configured to compare the current date and time with each of the predetermined user preferences such that selection of the preferred electronic credential from the plurality of electronic credentials may be based in some part on the current date and time as well as the current geo-location of the portable communication device.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless otherwise specified.

FIG. 1 illustrates an end user shaking the portable communication device to indicate that she desires to make a secure payment transaction at the current location using the preferences associated with the current location.

FIG. 2 illustrates the operable interconnections between the end user's smartphone and various subsystems, including the system management back end.

FIG. 3 is a block diagram illustrating some of the logical blocks within a portable communication device that may be relevant to the present system.

FIG. 4 is a block diagram illustrating an alternative embodiment of the “OpenWallet” block diagram of FIG. 4 having a location identification service.

FIG. 5 is a block diagram of one potential implementation of a system underlying the grant of permission for one of the third party apps 200 to view, select and/or change secure data stored in the payment subsystem.

FIG. 6A-6C are illustrations of screens from an exemplary mobile wallet user interface showing multiple exemplary credentials available in multiple categories.

FIGS. 7A-7C are illustrations of screens from an exemplary mobile wallet user interface showing one exemplary embodiment of how an end user may set and order preferences for one of the credentials in their mobile wallet.

FIG. 8 illustrates that some credentials will only have limited preferences that may be selected.

FIGS. 9, 10 and 11 together illustrate a preference conflict between two credential preferences in the wallet and one particular approach to resolving that conflict.

FIG. 12 illustrates an agent installed in the end user's portable communication device asking whether she would like to present multiple credentials at a point of sale;

FIG. 13 is a block diagram illustrating the prior art configuration of a Proximity Payment System Environment (PPSE) in a secure element 120 of a portable communication device for standard use with a legacy reader.

FIGS. 14, 15, and 16 are block diagrams illustrating various exemplary configurations of the Proximity Payment System Environment (PPSE) in the secure element 120 of the portable communication device for use in association with the present invention.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

### Portable Communication Device

The present invention provides a system and method that can be utilized with a variety of different portable communication devices, including but not limited to PDA's, cellular phones, smart phones, laptops, tablet computers, and other mobile devices that include cellular voice and data service as well as preferable access to consumer downloadable applications. One such portable communication device could be an iPhone, Motorola RAZR or DROID; however, the present invention is preferably platform and device independent. For example, the portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device.

The portable communication device includes one or more short proximity electromagnetic communication devices, such as an NFC, RFID, or Bluetooth transceiver. It is presently preferred to use an NFC baseband that is Compliant with NFC IP 1 standards (www.nfcforum.org), which provides standard functions like peer-to-peer data exchange, reader-writer mode (i.e., harvesting of information from RFID tags), and contactless card emulation (per the NFC IP 1 and ISO 14443 standards) when paired with a secure element on the portable communication device and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an NFC/RFID antenna (conformed to NFC IP 1 and ISO 14443 standards) to enable near field communications. However, as would be understood in the art NFC/RFID) communications may be accomplished albeit over even shorter ranges and potential read problems.

The portable communication device also includes a mobile network interface to establish and manage wireless communications with a mobile network operator. The mobile network interface uses one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (NIC). It is contemplated that the mobile network interface and short proximity electromagnetic communication device could share a transceiver or transceiving device, as would be understood in the art by those having the present specification, figures, and claims before them.

The portable communication device further includes a user interface that provides some means for the consumer to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. As would be understood in the art by those having the present specification, figures, and claims before them, the portable communication device may further include a location transceiver 400 that can determine the physical coordinates of device on the surface of the Earth typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (AGPS), E-OTD, CI, SAI, ETA, BSS or the like, to determine the physical location of the portable communication device on the surface of the Earth.

The portable communication device will also include a microprocessor and mass memory. The mass memory may include ROM, RAM as well as one or more removable memory cards. The mass memory provides storage for computer readable instructions and other data, including a basic input/output system (“BIOS”) and an operating system for controlling the operation of the portable communication device. The portable communication device will also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

In the present invention each portable communication device is thought to have two subsystems: (1) a “wireless subsystem” that enables communication and other data applications as has become commonplace with users of cellular telephones today, and (2) the “secure transactional subsystem” which may also be known as the “payment subsystem”. It is contemplated that this secure transactional subsystem will preferably include a Secure Element, similar (if not identical) to that described as part of the Global Platform 2.1.X, 2.2, or 2.2.X (www.globalplatform.org). The secure element has been implemented as a specialized, separate physical memory used for industry common practice of storing payment card track data used with industry common point of sale; additionally, other secure credentials that can be stored in the secure element include employment badge credentials (enterprise access controls), hotel and other card-based access systems and transit credentials.

### Mobile Network Operator

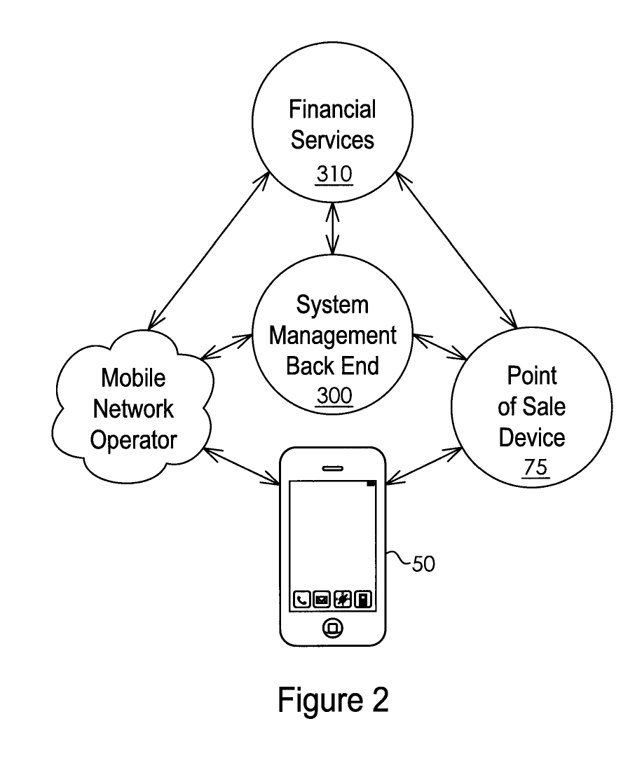

As shown in FIG. 2, each of the portable communications devices 50 is connected to at least one mobile network operator. The mobile network operator generally provides physical infrastructure that supports the wireless communication services, data applications and the secure transactional subsystem via a plurality of cell towers that communicate with a plurality of portable communication devices within each cell tower's associated cell. In turn, the cell towers may be in operable communication with the logical network of the mobile network operator, POTS, and the Internet to convey the communications and data within the mobile network operator's own logical network as well as to external networks including those of other mobile network operators. The mobile network operators generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the portable communication devices.

### Retail Subsystem

Standard at merchants today is an Internet Protocol connected payment system that allows for transaction processing of debit, credit, prepay, and gift products of banks and merchant service providers. By swiping a magnetic stripe enabled card at the magnetic reader of a Point of Sale Terminal 75 (see FIG. 2), the card data is transferred to the point of sale equipment and used to confirm funds by the issuing bank. This point of sale equipment has begun to include contactless card readers as accessories that allow for the payment card data to be presented over an RF interface, in lieu of the magnetic reader. The data is transferred to the reader through the RF interface by the ISO 14443 standard and proprietary payment applications like PayPass and Paywave, which transmit the contactless card data from a card and in the future a mobile device that includes a Payment Subsystem.

A retailer's point of sale device 75 may be connected to a network via a wireless or wired connection. This point of sale network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the point of sale network may utilize any communication method that allows information to travel between the point of sale devices and financial services providers for the purpose of validating, authorizing and ultimately capturing financial transactions at the point of sale for payment via the same financial service providers.

### System Management Back End

As also illustrated in FIG. 2, the system further includes a system management back end 300 connected to the retail subsystem, the secure transactional subsystem (made up of one or more financial service providers) 310, and to a plurality of portable communication devices 50 via the infrastructure of at least one mobile network operator. The system management back end 300 comprises a server operably communicating with one or more client devices. The server is also in operable communication with the retailer subsystem 75, secure transactional subsystem 310, and one or more portable communication devices 50. Any type of voice channel may be used in association with the present invention, including but not limited to VoIP.

The server of the system management back end 300 may comprise one or more general-purpose computers that implement the procedures and functions needed to run the system back office in serial or in parallel on the same computer or across a local or wide area network distributed on a plurality of computers and may even be located “in the cloud” (preferably subject to the provision of sufficient security). The computer(s) comprising the server may be controlled by Linux, Windows®, Windows CE, Unix, or a Java® based operating system, to name a few. The system management back end server is operably associated with mass memory that stores program code and data. Data may include one or more databases, text, spreadsheet, folder, file, or the like, that may be configured to maintain and store a knowledge base, user identifiers (ESN, IMSI, PIN, telephone number, emailaM address, billing information, or the like).

The system management back end server supports a case management system to provide call traffic connectivity and distribution across the client computers in the customer care center. In a preferred approach using VoIP voice channel connectivity, the case management system is a contact/case management system distributed by Contactual, Inc. of Redwood City, Calif. The Contactual system is a standard CRM system for a VoIP-based customer care call center that also provides flexibility to handle care issues with simultaneous payments and cellular-related care concerns. As would be understood by one of ordinary skill in the art having the present specification, drawings and claims before them other case management systems may be utilized within the present invention such as Salesforce (Salesforce.com, inc. of San Francisco, Calif.) and Novo (Novo Solutions, Inc. of Virginia Beach, Va.).

Each client computer associated with the system management back end server has a network interface device, graphical user interface, and voice communication capabilities that match the voice channel(s) supported by the client care center server, such as VoIP. Each client computer can request status of both the cellular and secure transactional subsystems of a portable communication device. This status may include the contents of the soft memory and core performance of portable communication device, the NFC components: baseband, NFC antenna, secure element status and identification.

### Secure Transactional Subsystem

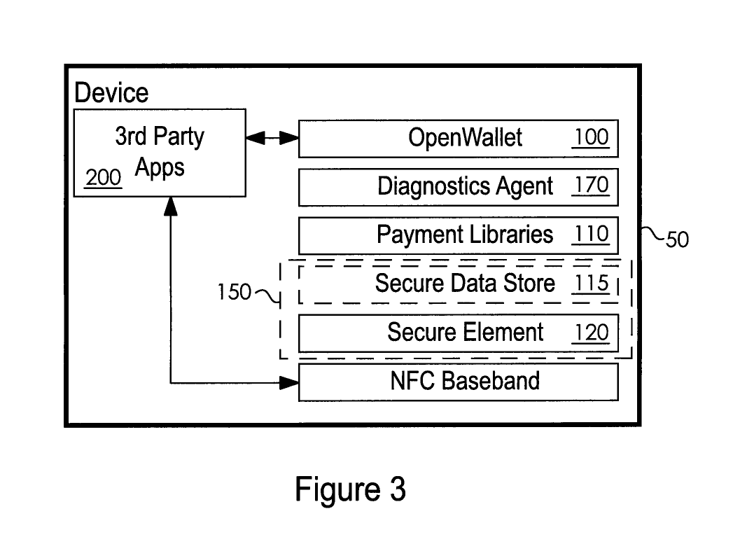

As shown in FIG. 3, the portable communication device 50 includes a secure transactional subsystem 150. The secure transactional subsystem 150 includes the secure element 120 and associated device software for communication to management and provisioning systems as well as the customer facing interface for use and management of secure data stored in the secure element. Preferably the secure transactional subsystem will conform, where appropriate, to an international standard, such as the standard defined in Global Platform 2.1.X or 2.2. As shown in FIG. 2, a secure data store 115 may also be included in secure transactional subsystem 150.

Where the secure element 120 has multiple credentials, the desire and even need to present more than one of those credentials in a single transaction is likely to arise. For instance, a user may want to split the cost of a transaction between two credit cards, a credit card and debit card, or the like. In another example, where the electronic payment system also stores coupons or other discount offers the user may desire to use the coupons and then place the remaining balance on an electronic credit card. As would be understood by those having the present specification before them the possible permutations are endless.

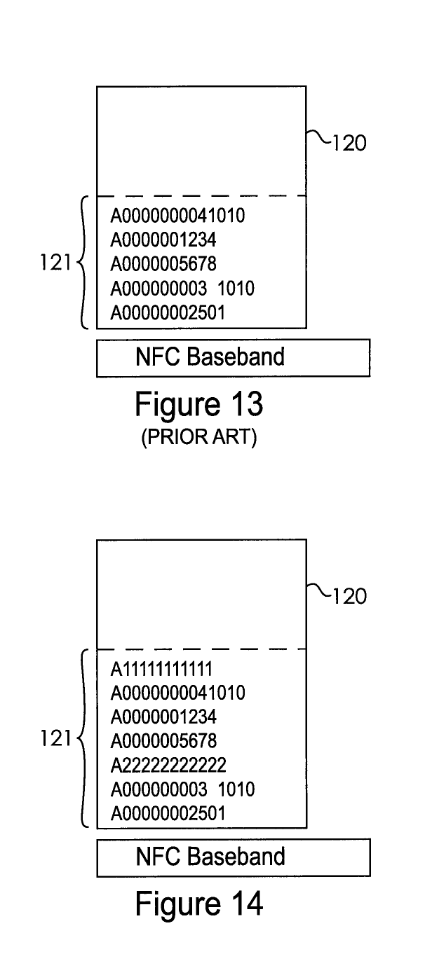

The secure element 120 is commonly compliant with the EMVCo specifications. Secure elements that follow EMVCo specifications employ Proximity Payment System Environment (PPSE), where the PPSE is a directory of available credentials currently stored in the secure elements. As shown in FIG. 13, each credential stored in such a secure element is assigned an Application ID (AID) (which AID was preferably registered by an ISO/IEC 7816-5 registration authority), and stored in the PPSE. These AIDs are stored in priority order in the PPSE 121, with the first AID having the highest priority, the second AID having the next lower priority, and so on.

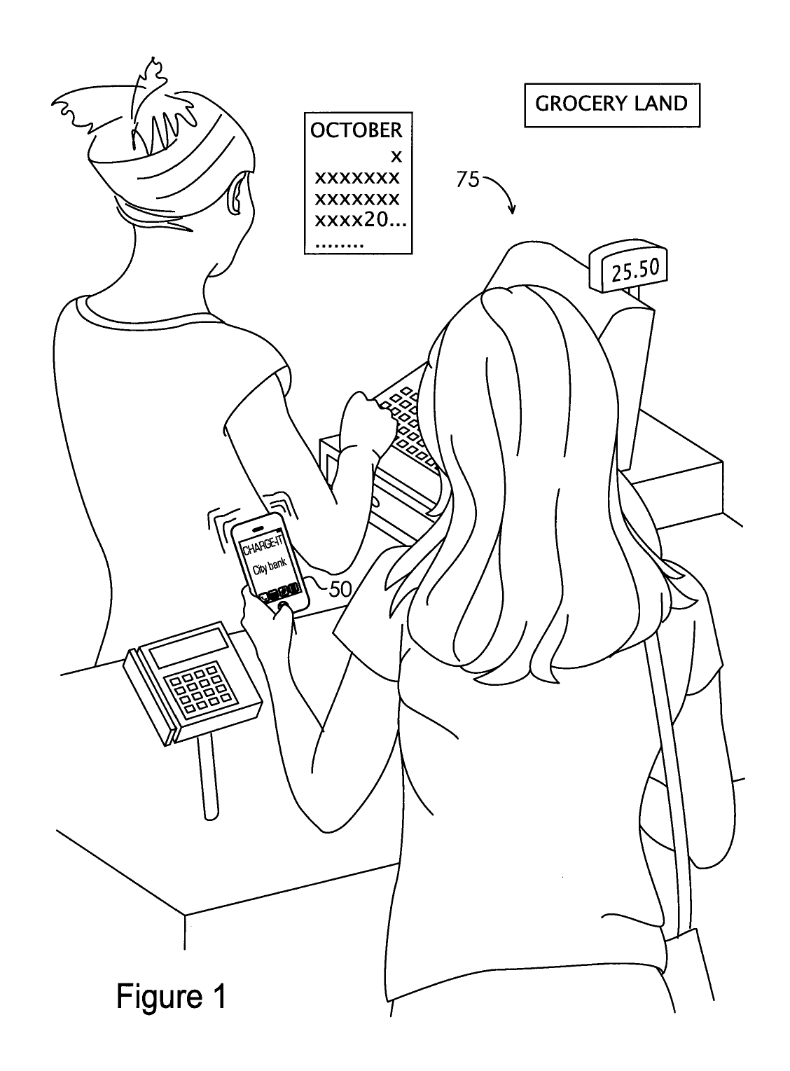

When the portable communication device 50 is brought near a contactless reader (as illustrated in FIG. 1), the portable communication device 50 emulates the first (or top) credential in the PPSE. If the contactless reader is capable of reading the first credential, it reads the credential and upon successfully reading that credential generally provides some user-perceivable indication of success (e.g. sounding a pleasant beep and/or illuminating a LED on the reader housing), and then it completes the transaction with the appropriate financial services provider (via the network connected to the retailer's point of sale device 75). If the contactless reader does not recognize the first credential emulated then the device 50 may emulate the next subsequent credential in the PPSE and so on and so forth until the device 50 emulates a credential recognized by the reader. Conversely, some of communications devices 50 may be unable emulate certain credentials. In such cases where that type of credential is found in the PPSE, the device 50 will skip over the credential to the next subsequent credential in the PPSE.

The function of the PPSE may be illustrated with the credentials depicted in PPSE 121 of FIG. 13. In particular, FIG. 13 depicts an example of PPSE 121 having a first credential, which for sake of illustration we will refer to as being a MASTERCARD credit card with the code A0000000041010, a second credential we will call a digital coupon having the code A0000001234, a third credential we will call another digital coupon having the code A0000005678, a fourth credential we will refer to as a VISA® credit card having the code A000000003 1010), and a fifth credential we will call an AMERICAN EXPRESS® credit card having the code A00000002501. As would be understood by those skilled in the art having the present specification, drawings, and claims before them, these AID codes are merely illustrations of the variety of codes that may be stored in a PPSE/secure element. The number of credentials that can be stored in the PPSE or otherwise in a secure element is a function of the size limitation of the secure element.

In the legacy mode of operation under our present example, the arrangement of the PPSE depicted in FIG. 13 would indicate that the wallet was configured to present the MASTERCARD® credit card as the primary credential from the electronic wallet (as it is at the top of the PPSE 121). After examining the PPSE, a contactless reader that supports the MASTERCARD® credential should accept the MASTERCARD card credential (i.e. A0000000041010) being emulated from the portable communication device 50. According to existing EMVCo specifications, once the attempt to accept the MASTERCARD® credential has completed, the communication between the card and the reader would end. If the reader is not capable of reading the MASTERCARD® credential it will next attempt to read the second credential in the PPSE, which has been illustrated by code A0000001234, which has been described—for purposes of our illustrative example—as being a digital coupon. As few, if any readers, at the time of this filing, have been programmed to accept digital coupons, the reader will likely not accept this credential and continue to “down” the PPSE 121 reading the third credential unsuccessfully (another coupon in our example) until reaching the fourth credential, e.g., A000000003 1010, which has been described in our illustrative example as being a VISA® credit card credential. In our example the reader would be capable of reading a VISA® credential, so this fourth credential in the PPSE would be read successfully, with an indication of success given by the reader, and communication between the secure element 120 and contactless card reader would end.

The foregoing examples notwithstanding, in nearly all of the hundreds of millions of smart cards and wallet-enabled portable communication devices in use today, there is only one set of card data inside the secure element and, therefore, only one AID in the PPSE. In this common case, a contactless reader examines the PPSE, finds the sole AID, and then uses that single AID to communicate to the credentials from the smart card to the reader at the point of sale device. If the sole AID is unrecognized by the particular reader, then the attempted contactless transaction fails.

With a user interface and larger memory sizes, a secure element in a portable communication device could easily be used to store and manage multiple sets of credentials. For instance, these credentials may include multiple credit cards, debit cards as well as digital coupons. New credential types can be programmed into legacy readers in the same way that credit (and debit) cards have previously been programmed into the readers (and associated secure elements). However, merely programming additional credential types into the readers will not be fully useful because readers will still only read the PPSE from “top” to “bottom” until the first recognized credential is successfully read and then communications between the secure element and reader would terminate. And a second, subsequent attempted communication between portable communication device and reader would only result in the reader reading the same credential from the top of the PPSE 121a second time.

The present system and method further establishes uniquely created AIDs that are defined to instruct legacy card readers to execute advanced functions, such as multiple credential presentation and the provision of digital receipt printing capability via the secure element. By using AIDs to represent instructions instead of just the credentials that AIDs were intended to represent, the PPSE 121 would act as a simple messaging interface between the secure element 120 and a reader. Each legacy reader would be updated to recognize the newly created command AIDs in the same general manner that contactless readers are updated now (e.g. a technician locally downloads a new file to the reader using a USB memory device). Of course, after the introduction of this idea to the mark the contactless card readers will be initially designed/programmed to recognize the command AIDs that will established within the contactless payment industry based on the present invention.

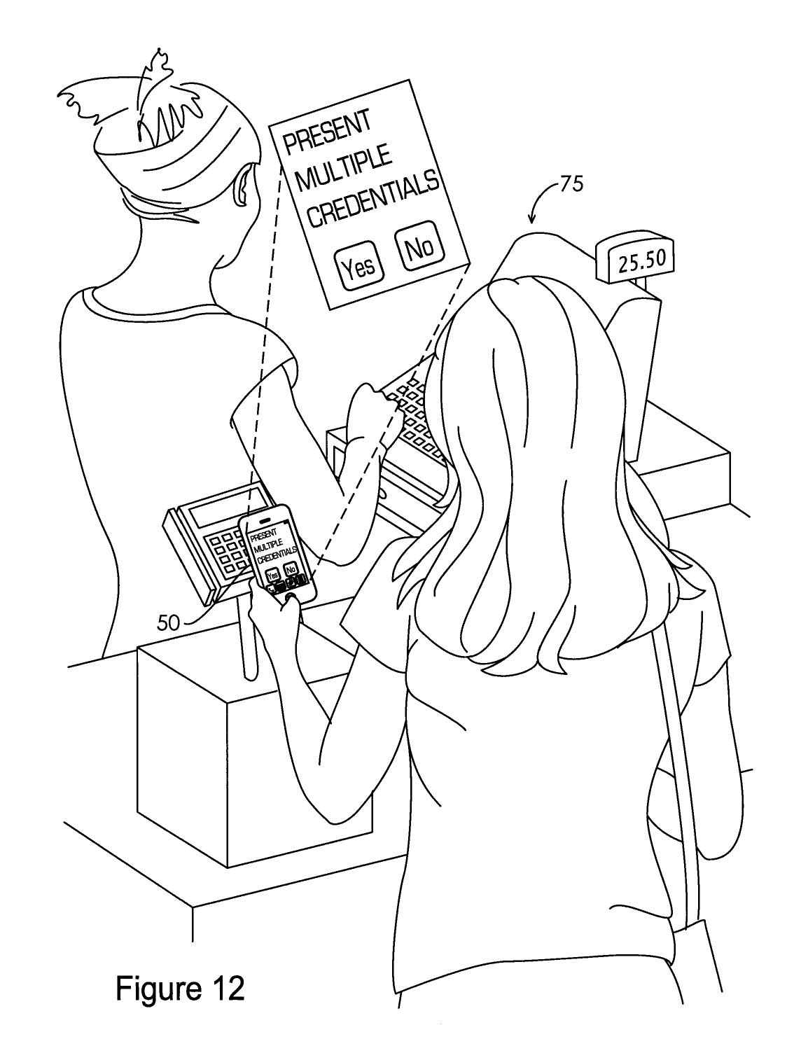

So, for illustration purposes let's assume the contactless reader in FIG. 1 has been reprogrammed to recognize command AIDs as well as the AIDs for various credentials, including, but not limited to, coupons and payment cards. If a user has the desire to submit their MASTERCARD credential and the two digital coupon credentials to the reader (these credentials having already been described in association with FIG. 13 above), the user would indicate this desire to use multiple credentials via the user interface of the device 50. One potential approach has been illustrated in association with FIG. 12. If the user selects “yes” on the user interface to question about the presentation of multiple credentials, the user interface would offer a listing of the available credentials in the PPSE 121 for the user to select for presentation in the transaction. Based on those selections, the payment libraries 110 in combination with the management applet on the secure element 120 would rearrange the credentials in the PPSE 121 in accordance with the user's selections to facilitate the presentation of two or more NFC credentials in a single transaction. The simplicity of memory management in current secure elements would require the use of one or more secure memory locations preferably within the secure element and more preferably in the PPSE to swap credentials back and forth to reorder the PPSE. In some embodiments, the portable communication device may include a virtual secure element, which may also be used for storing credentials and as temporary memory registers during the credential swapping process in the PPSE.

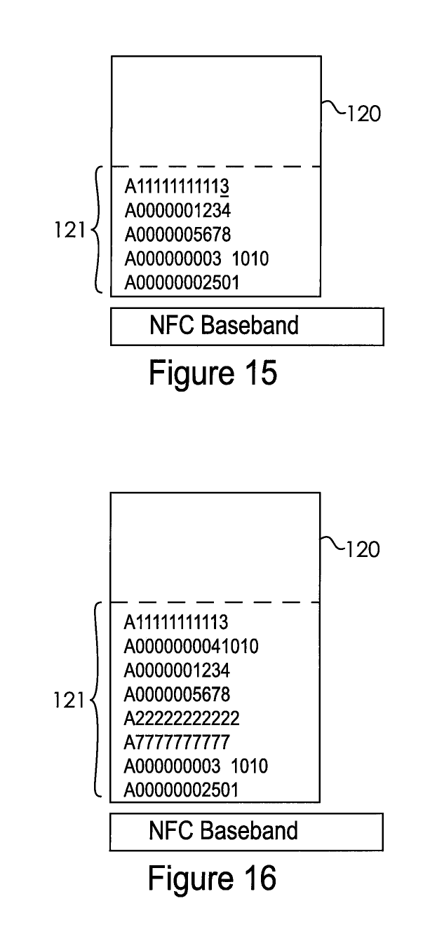

FIG. 14 depicts an exemplary configuration of the PPSE 121 to facilitate the presentation of multiple credentials in a single NFC transaction. First, FIG. 14 illustrates the addition of a pre-determined multi-credential START-code AID 700 to the PPSE 121. As the name suggests, START-code AID 700 will indicate to updated contactless card readers the beginning of a multiple credential data transmission. As depicted in FIG. 14, multi-credential START-code AID 700 could be assigned a pre-determined code A11111111111. However, as should be understood by those of ordinary skill in the art having the present specification, drawings, and claims before them, any pre-determined constant may be used for this purpose so long as the constant is unique. Most preferably AID 700 should not be the same value as any validly issued credentials. Conversely, whatever constant is selected for the pre-determined multi-credential START-code AID 700 should be reserved for the purposes disclosed herein. FIG. 14 further illustrates a pre-determined multi-credential END-code AID 750 has also been illustrated. As the name suggests, END-code AID 750 will indicate to updated contactless card readers the end of the multiple credential transmission data. As depicted in FIG. 14, AID 750 has been given the constant value A22222222222. Here again, the designers should preselect the value for the pre-determined multi-credential END-code AID 750 to avoid duplicating previously assigned credential codes and the selected END-code AID should ultimately be reserved for this use. It is contemplated that the pre-determined command AIDs could dynamically altered by the secure element in a preproduceable manner that would also be known to the readers to enhance the security of the command transaction.

As in the prior art, the PPSE 121 still contains credentials. In the example of FIG. 14, because they are presented between the A11111111111 and A22222222222 AID command codes, the MASTERCARD® credential (ending with 010), and two digital coupon credentials (ending in 234 and 678, respectively) would be presented to the contactless card reader during the same NFC transaction. To further illustrate the points regarding presentation and reorganization of credentials within the PPSE 121, FIG. 14 depicts two more NFC credentials after the pre-determined END-code AID 750 (A22222222222). These two credentials will not presented to the NFC Baseband during the single transaction because they are loaded in the PPSE 121 after the END AID command. Thus, a secure element and reader that supports the new method would recognize the START-code AID 700 indicator (A11111111111) and understand that the user of this secure element 120 has indicated that multiple credentials should be transferred to the reader in the same session. The reader would accept the MASTERCARD® card credential, the digital coupon '1234 credential, the digital coupon '5678 credential. The appropriate credentials can be presented during or after the check-out process. Upon detecting the end AID, the reader would stop attempting to read further credentials and end the session with the secure element.

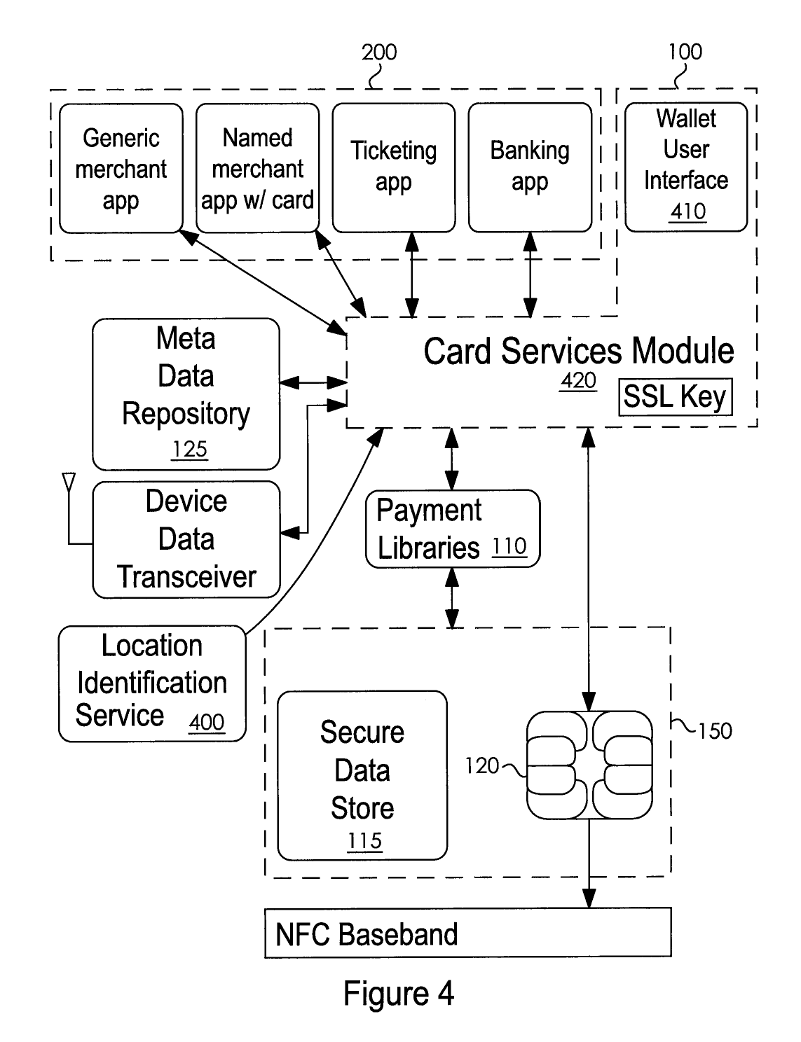

This system and method is also backwards compatible with legacy readers that have not been reprogrammed with command AIDs. For instance, with reference to the illustration of FIG. 4, an un-updated reader would try to read START-code AID 700 indicator A11111111111 because it is at the top of the PPSE 121. By definition, this un-updated reader will not recognize this AID credential and then read the next credential in the PPSE 121, which in the example of FIG. 4 is the MASTERCARD credential (ending with 010). The reader would recognize the MASTERCARD® credential and just as illustrated in the prior art example of FIG. 13 execute on the MASTERCARD® credential. To further support this backward compatibility, the user interface may force the user to list multiple credentials for presentation by the probability that a reader will recognize the credential. For instance, credit card NFC credentials have long been known in this art, so they would be forced to the top of any user selection of multiple credentials.

An alternative approach is illustrated in FIG. 15. In this illustration of the present invention only a START-code AID constant is used. This “constant” has a final digit that is varied to reflect the number of credentials that reader should expect to have presented during the single transaction. As illustrated, the pre-determined AID multi-credential start word has been slightly modified to indicate that three credentials are intended for transfer (e.g. A11111111112). (The underlining illustrated is merely for emphasis and would not actually occur in the PPSE). So, the start AID would prepare an updated reader to expect three credentials during the single transaction, and thus will run its read-accept cycle three times traveling down the PPSE 121. The result will be the reader receiving the credentials A0000001234 (a digital coupon), A000005678 (another digital coupon) and A000000003 1010 (a VISA® card credential) in three separate reads of the single NFC transaction. In addition to payments, FIG. 15 is also illustrative for presenting coupons at the time of purchase of goods or services.

NFC baseband subsystems found within devices 50 are fundamentally capable of transferring information from the reader to the device. Examples of this usage scenario include: sending digital receipts back from the reader to the portable communication device 50 at the end of the transaction. FIG. 16 illustrates a method for achieving this scenario with the addition of another pre-determined AID constant 770 (A7777777777) that would be pre-defined to instruct the reader to push data back to the secure element 120, which reads the NFC reader data into the device 50 via the NFC Baseband.

### Federated Payment Subsystem

As shown in FIG. 3, each portable communication device 50 may contain one or more third party applications 200 (e.g. selected by the consumer), OpenWallet 100, payment libraries 110, secure element 120, an NFC Baseband, a payment subsystem 150 (i.e. secure data store 115 and secure element 120), and diagnostic agent 170. OpenWallet 100 is a computer application that allows the consumer to see all credentials (e.g, card, coupon, access control and ticket data) stored in the device 50 (preferably in payment subsystem 150). OpenWallet 100 would also preferably track the issuers of all the credentials stored in the portable communication device's payment subsystem 150 and determine on an application-by-application basis whether that third party application should have permissions to view, select and/or change the credentials stored in the payment subsystem. In this manner, OpenWallet 100 also prevents unauthorized applications from accessing data stored in the payment subsystem 150, which they do not currently have permission to access.

The payment libraries 110 are used by OpenWallet 100 to manage (and perform housekeeping tasks on) the secure element 120, interface with the system management back end, and perform over-the-air (OTA) provisioning via data communication transceiver (including its SMS channel), on the device 50. It is contemplated that the OTA data communications will be encrypted in some manner and an encryption key will be deployed in card service module 420. The payment subsystem 150 may be used to store credentials such as payment card, coupon, access control and ticket data (e.g. transportation, concert). Some of these payment types may be added to the payment subsystem by different applications 200 for use by those applications. In this manner, other third party applications (not shown) may be precluded from accessing the payment subsystem 150.

The secure data store 115 provides secured storage on the portable communication device 50. Various levels of security may be provided depending upon the nature of the data intended for storage in secure data store 115. For instance, secure data store 115 may simply be password-protected at the operating system level of device 50. As is known in these operating systems, the password may be a simple alphanumeric or hexadecimal code that is stored somewhere on the device 50. Alternatively, the data in secure data store 115 is preferably encrypted. More likely, however, the secure data store 115 will be set up as a virtual secure element in the manner disclosed in the co-pending patent application (owned by the assignee of the present application) entitled “System and Method for Providing A Virtual Secure Element on a Portable Communication Device” filed contemporaneously herewith and hereby incorporated by reference.

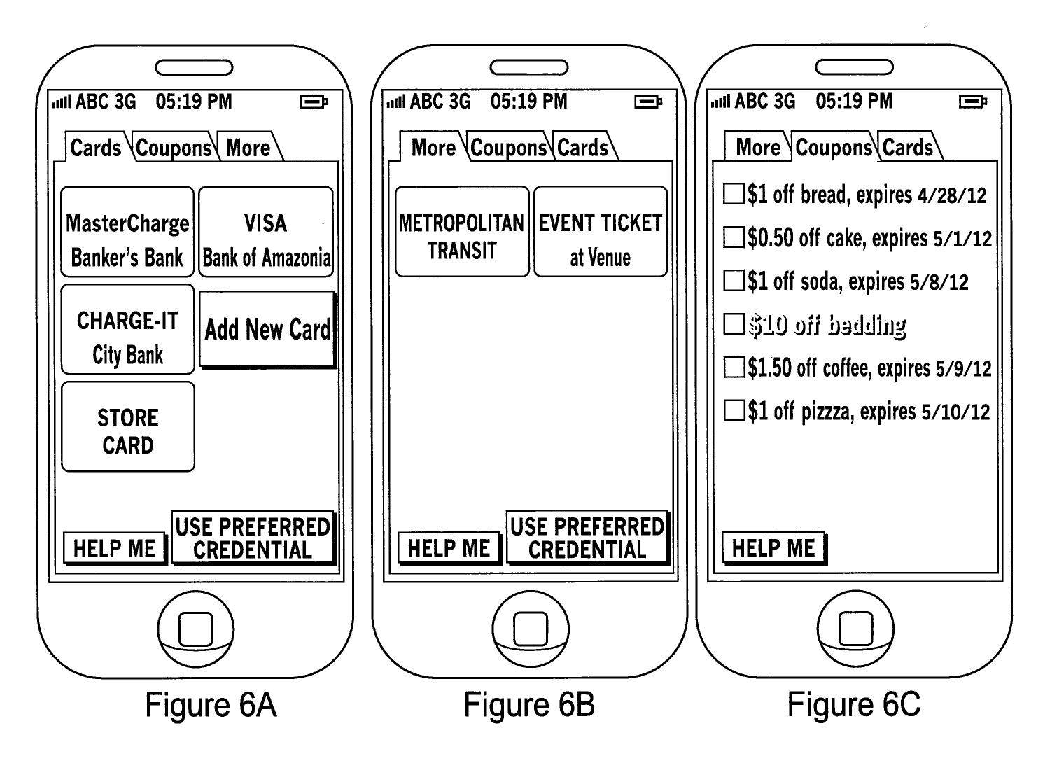

OpenWallet 100 preferably removes the complexity involved in the storage, maintenance and use of credentials such as card, coupon, ticket, access control data from one or multiple sources or issuers in association with the payment subsystem 150. OpenWallet 100 also preferably enforces access control to the data stored in the payment subsystem 150 and the functions allowed by each application. In one approach, OpenWallet 100 verifies the author/issuer of each third party application stored on the portable communication device 50. This verification may be accomplished by accessing a local authorization database of permitted (i.e., trusted) applications (see FIG. 6). Under this approach, only applications that are signed with a known Issuer ID and the correctly associated Compile ID are allowed by card services module 420 to access and/or manipulate data stored in the payment subsystem 150 and/or meta data repository 125 (which stores, among other things, card image data and any embossed card data).

In other words, when an application 200 or wallet user interface 410 needs to interact with the payment subsystem 150 it does so by passing a digital identifier (such as its Issuer ID or App ID), a digital token (i.e., Compile ID or Secret Token ID), the desired action, and any associated arguments needed for the action to the card services module 420. Card services module 420 verifies the digital identifier-digital token pair matches trusted application data in the secure data table (FIG. 6), and then would issue the one or more commands necessary to execute the desired action. Among the potential actions that may be used by applications 200 or wallet user interface 410 are those associated with:
a. wallet management (e.g. setting, resetting or enabling wallet passcodes; get URL of OTA server; over-the-air registry provisioning; setting payment timing; increasing payment timing; set default card; list issuers, list supported credentials; set display sequence of credentials; set credential storage priority; create categories/folders; associate credentials with categories; memory audit; determine SE for storage of credential; get Offers; update wallet status);
b. credential management (e.g. add credential; view credential detail; delete credential; activate credential (for redemption/payment); deactivate credential; search credentials; list credential capability; set default credential; lock/unlock credential; require passcode access; get credential image; set access passcode);
c. Secure Element (SE) Management (e.g. get credential; update credential; update meta data; delete credential; wallet lock/unlock; SE lock/unlock);
d. Personalization (e.g. add credential; delete credential; suspend/unsuspend credential; notification for issuer metadata update; notification for card metadata update).

FIG. 4 illustrates further detail of the “OpenWallet” block of FIG. 2. As shown, the functions of “OpenWallet” 100 can be integrated into a single dedicated module that provides a user interface that is closely coupled to the card services. In another embodiment illustrated in FIG. 4, the capabilities and functionality of OpenWallet 100 may be distributed between a Wallet User Interface 410 and a Card Services Module 420. The distributed approach would allow applications to have direct access to the Card Services Module 420 without having to use the user interface provided by Wallet User Interface 410. The Card Services Module 420 may be configured to track the issuer of all card, coupon, access and ticket data stored in the payment subsystem 150 of the portable communication device 50 and determine on an application-by-application basis whether an application should have permissions to view, select, use and/or change secure data stored in the payment subsystem. The wallet user interface 410 provides a user interface through which a user may register, provision, access and/or use the information securely stored in association with the card services module 420 relating to the user's credentials. Because the wallet user interface 410 is separated from the card services module 420, the user may elect to use one of the third party applications 200 to manage information in the Card Services Module 420. As further shown in FIG. 4, metadata (such as credential logos (e.g. Amtrak®, MASTERCARD®, TicketMaster®, and VISA®) and affinity images (e.g. AA Advantage® and United Mileage Plus®) may be stored in memory 125 for use by the third party apps 200 or wallet user interface 410 in rendering a more friendly user experience. As this metadata can be shared across applications, the storage needed to implement secured transaction may be minimized.

### Validating Third Party Applications

As noted above, OpenWallet 100 verifies the trusted status of any third party application 200 before that application is allowed access to the secure element 120 (or secure data store 115 and even preferably the meta data repository 125) on the portable communication device 50 to view, select and/or change secure data stored in the payment subsystem 150. In one approach noted above, this verification may be accomplished by accessing a local authorization database of permitted or trusted applications. In a preferred approach, the local authorization database in cooperates with a remote authorization database associated with one or more servers associated with system management back end 300.

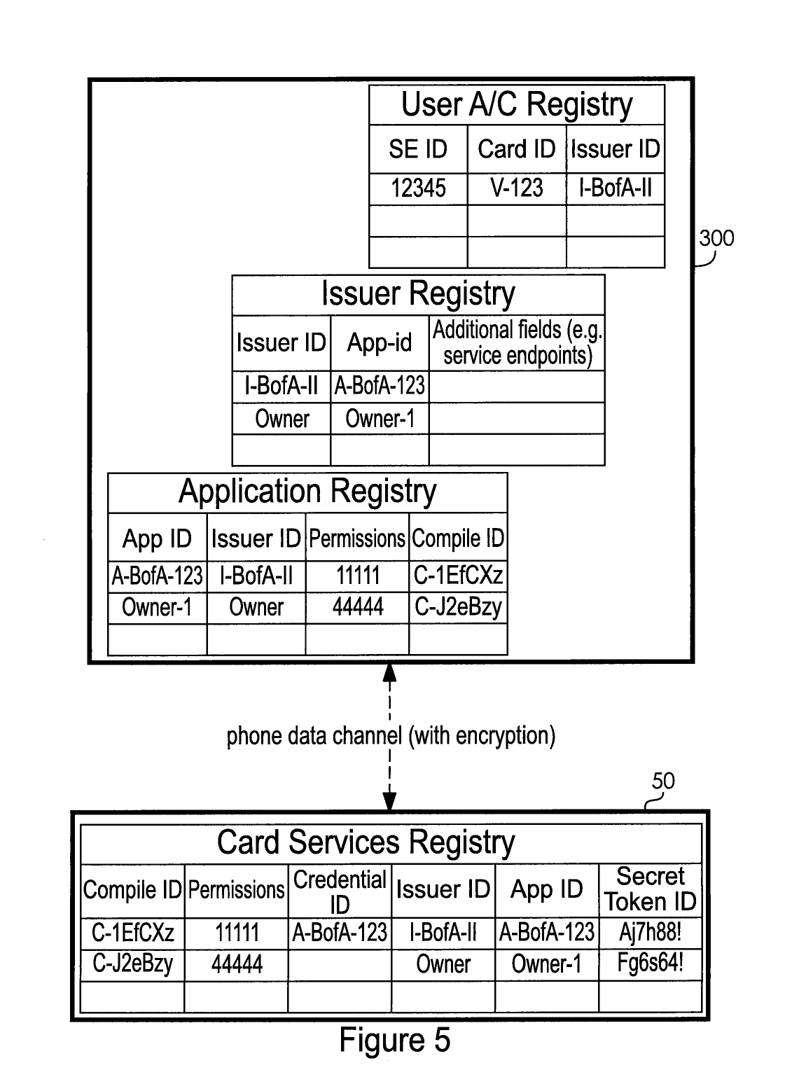

FIG. 5 is a block diagram of one potential implementation of one potential combination local and remote authorization databases to enhance security of the card services module 420, secure element 120, and payment subsystem 150. As shown in FIG. 5, a User A/C Registry (or User Account Registry) may be associated with the server (or otherwise deployed in the cloud). The User A/C Registry may store the identification of the secure element 120 disposed in each user's portable device 50. Entries in the User Account Registry may be added for each user at any point in the process.

The “Issuer Registry” database is a database of approved Issuers. The Issuer ID is unique for each type of credential. In other words, if a bank has multiple types of credentials (e.g. debit cards, credit cards, affinity cards, etc.) each credential type would have its own Issuer ID (e.g. I-BofA-II). In a preferred approach, the Issuer ID as between multiple types of credentials would have some common elements, so as to indicated that the credentials are at least related (e.g. I-BofA-I). In this way applications from same issuer can share data with the other application of the same “extended” issuer. In a preferred approach, card services module 420 can be simplified by requiring even the wallet user interface 410 (which “ships with the system”) to have an Issuer ID (and as well as an Application ID and Compile token).

The “Application Registry” is a database of applications (mostly third party) that have pre-approved by an operating system provider. Like the User A/C Registry, the “Application Registry” and “Issuer Registry” database are maintained on the server side (or otherwise in the cloud) in operable association with OpenIssuance (see FIG. 3). As would be understood by those of ordinary skill in the art having the present specification before them, the various registries may be implemented in separate databases or one unified database. At initiation of a wallet 100 and preferably at substantially regular time-intervals thereafter (e.g., daily), the data stored in the Application Registry of Open Issuance (see FIG. 3) is distributed to devices with the wallet to be stored locally.

As shown in FIG. 5, the Application Registry may include, among other information, an Application ID (“App ID”), an Issuer ID, and a Compile ID or token. The Compile ID is a global constant generated for each application by one or more processes associated with Open Issuance during the qualification process for the particular application 200. After it is generated by a particular card services module 420 on a unique device 50, the Compile token is included or otherwise associated with the application. This Compile token is preferably generated by a pseudo-random number generator local to the device that uses a pre-determined seed, such as the Application ID, Compile ID, Issuer ID or some combination thereof.

When the user seeks to qualify a third party application with the card services module 420 on a device 50, the Compile ID (a digital token) and Application ID (a digital identifier) associated with the third party application may be matched against the Compile ID and Application ID pairs stored in the Card Services Registry stored on the device 50 (see FIG. 5). As should be understood by those skilled in the art having the present specification before them, the same Compile and Application ID pairs are transmitted to other devices 50 associated with the system, as well. If the Compile ID/Application ID pair matches one of the pair-stored in the Card Services Registry on the device, a Secret Token ID is preferably generated on the device 50 by a pseudo-random number generator (such as the one associated with the Secure Element 120 and then stored in association with the Compile ID/Application ID pair in the Card Services Registry on the device 50. In some instances, the Compile ID may be pre-selected and used to seed the random number generator. It should be understood that one or more pieces of other predetermined data associated with the card services registry could be preselected as the seed instead. The card services Registry is preferably stored in secure memory (rather than the secure element 120 because secure element 120 has limited real estate) and the Card Services Registry is preferably further encrypted using standard encryption techniques. The Secret Token ID is also embedded in or otherwise associated with the application 200 on the device 50 in place of the Compile ID that was distributed with the application.

After the application has been loaded into the Card Services Registry (and the secret token embedded in the application), the third party may launch and may prompt the user to opt-in to provide access to the issuer-specific credential needed for the validated (or trusted) application. In each subsequent launch of the third party trusted application, the embedded Secret Token and/or Application ID are compared to the data in the Card Services Registry on the device. If there is match, the application is trusted and can access the payment subsystem 150 via card service module 420. In this manner, it can be seen that applications 200 or wallet user interface 410 may also be removed from the Card Services Registry and thus would be disabled from accessing the payment subsystem and possibly the application, altogether.

Card services module 420 also preferably uses the trusted application verification step to determine the appropriate level of subsystem access allowed for each application 200. For example, in one embodiment, one application 200a may be authorized to access and display all of the data contained in the payment subsystem 150, where another third party application 200x may be only authorized to access and display a subset of the data contained in the payment subsystem 150. In yet another embodiment, an application may be permitted only to send a payment or transaction requests to OpenWallet 100, but may not itself be permitted to access any of the data contained in the payment subsystem 150. In one approach, assignment of permissions to the application can be thought of as follows:

| | | All | Extended Issuer | Own |
|---|---|---|---|---|
| | Reserved | Credentials | Credentials | Credentials |
| Read | 0 | 0 or 1 | 0 or 1 | 0 or 1 |
| Write | 0 | 0 or 1 | 0 or 1 | 0 or 1 |
| Delete | 0 | 0 or 1 | 0 or 1 | 0 or 1 |
| Activate/ | 0 | 0 or 1 | 0 or 1 | 0 or 1 |
| Deactivate | | | | |
| Download | 0 | 0 or 1 | 0 or 1 | 0 or 1 |
| Credential | | | | |

These permission can be used to form 4 hexadecimal number in the order shown above from most to least significant figure. As shown in the example Card Services Registry of FIG. 6, the I-BofA-II issuer has permission level 11111, which can be thought to expand to 0001 0001 0001 0001 0001. In other words, the I-BofA-II application can read, write, delete, activate/deactivate, and download its own credentials but not the extended issuer credentials let alone all credentials. If BofA had another issuer code (e.g. I-BofA-I), then that would be an extended Issuer application. So, if the permission level of the application associated with Issuer ID “I-BofA-II” was set to 0010 0001 0001 0010 0001 (or 21121 hexadecimal) then the application would be able to read and activate/deactivate the credentials associated with both issuer IDs. In yet another example, the wallet user interface 410 may be given a permission level of 44444 (i.e. 0100 0100 0100 0100 0100). In other words, the wallet user interface 410 can read, write, delete, activate/deactivate, and download all credentials. As would be understood by those of ordinary skill in the art, these are merely examples of potential permissions that can be granted to applications, other permissions are contemplated. For instance, some applications may have the ability to read extended issuer credentials, but only write, delete, activate and download the application's own credentials (e.g. 21111, which expands to 0010 0001 0001 0001 0001). In yet another example, an application may only be given activate/deactivate and download rights (e.g. 0000 0000 0000 0001 0001 or 00011 in hexadecimal). In yet another example, an application may be disabled—without being deleted from the trusted application database or Card Service Registry—by setting all rights to zero.

### Contactless Data Emulation Based On Physical World Geo-Location

Where the consumer's portable communication device has geo-location capability (e.g. GPS, Control Plane Location, and/or GSM Localization), OpenWallet automatically queries the device's geo-location capability (i.e. location identification service 400 in FIG. 4) and/or prompts the consumer to enter the location of the portable communication device. OpenWallet 100 transmits the customer location information using most appropriate channel to the server. Based on the received customer location information, the server performs database query to determine which contactless point of sale terminal is installed (or likely to be installed) at consumer's location. In a preferred embodiment, the user interface associated with the portable communication device 50 may alternatively display a list of the next most likely retail stores (e.g. the next top five or top ten possibilities) where the phone may be located. Based on the identified location and/or point of sale terminal, the OpenWallet module of the portable communication device 50 configures the payment system with the data formats and other contact-less point of sale data specific to this location and/or point of sale are supported or optimal for presentation of card, coupon, ticket or access control emulation. In particular, Card Services Module 420 would order the credentials in the PPSE 121 to align—where possible—with the credential preference for the current physical retailer location.

The location-based system disclosed in association with FIG. 4 may also facilitate an end user's streamlining their mobile wallet transactions in view of their geo-location (and other factors potentially, such as the date and time). In association with this functionality, it may be further possible to program the card service module 420 to sense particularly abrupt motions of the portable device (via an accelerometer for instance) to activate a pre-selected (or dynamically-selected) credential. For example, in FIG. 1, an end user is shown shaking her portable communication device to activate the preferred credential pre-associated with her current location in Grocery Land on October 20th. As would be understood by those of skill in the art having the present specification, drawings, and claims before them, a number of alternative means for activating the location-based preference service are possible, such as, for example, using a voice prompt or swiping one or more fingers across the user interface. Regardless of how the location-based services are activated, once activated, card service module 420 gathers the location of the device from location identification service 400 and determines whether the end user stated a credential preference for the present location. This preference will preferably be balanced with any credential preference known to be associated with the merchants' point of sale devices (as discussed above).

The location information provided by location identification service 400 may be categorized by the card service module 420 into consumer-based categories (e.g., grocery, gas station, drug store, fashion, beauty, etc.) or any other categorization scheme that may improve the user experience with the OpenWallet 100. Once the store and/or category (or other predetermined criterion associated with the location) is determined, the user's preset preferences may be used to automatically determine which credential to use for the transaction.

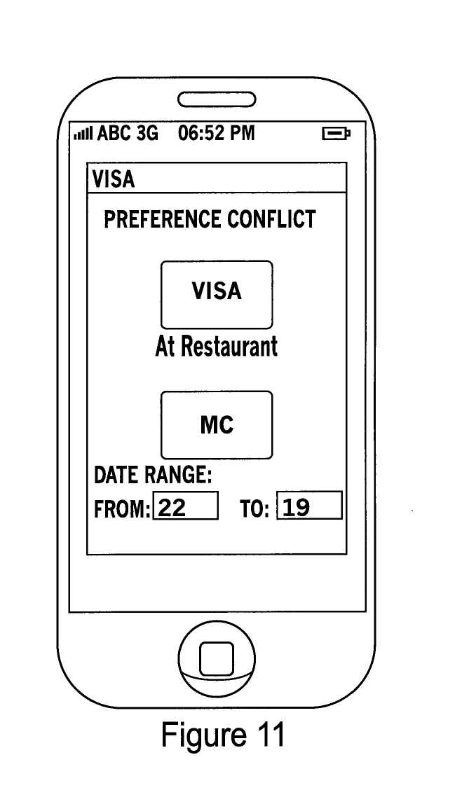

FIGS. 6A-6C illustrate screens from an exemplary mobile wallet user interface showing multiple credentials available in multiple categories. In particular, FIG. 6A illustrates four (4) payment cards or credentials, plus an option to add a new card. FIG. 6B illustrates that the wallet can contain a transit credential as well as one or more tickets for an event (e.g. a live theater performance at the Center for Performing Arts; a Bruce Springsteen and the E Street Band concert at the HP Pavillion at San Jose, Calif.; Sacramento Kings vs. New Orleans Hornets at Power Balance Pavilion). Of course, these event ticket credentials are only useful in one location at one particular time, particularly where the venue uses NFC readers to control access to the event. The Metropolitan Transit ticket provides a similar opportunity to limit credential usage to a particular location or set of locations. A similar scenario could be seen with a credential for admission to a movie theater chain. FIG. 9C also show coupons stored as credentials in the wallet. As illustrated in FIG. 9C, the coupons may be sortable by expiration date and may be illustrated as being unavailable at a particular location (as will be described more fully below).

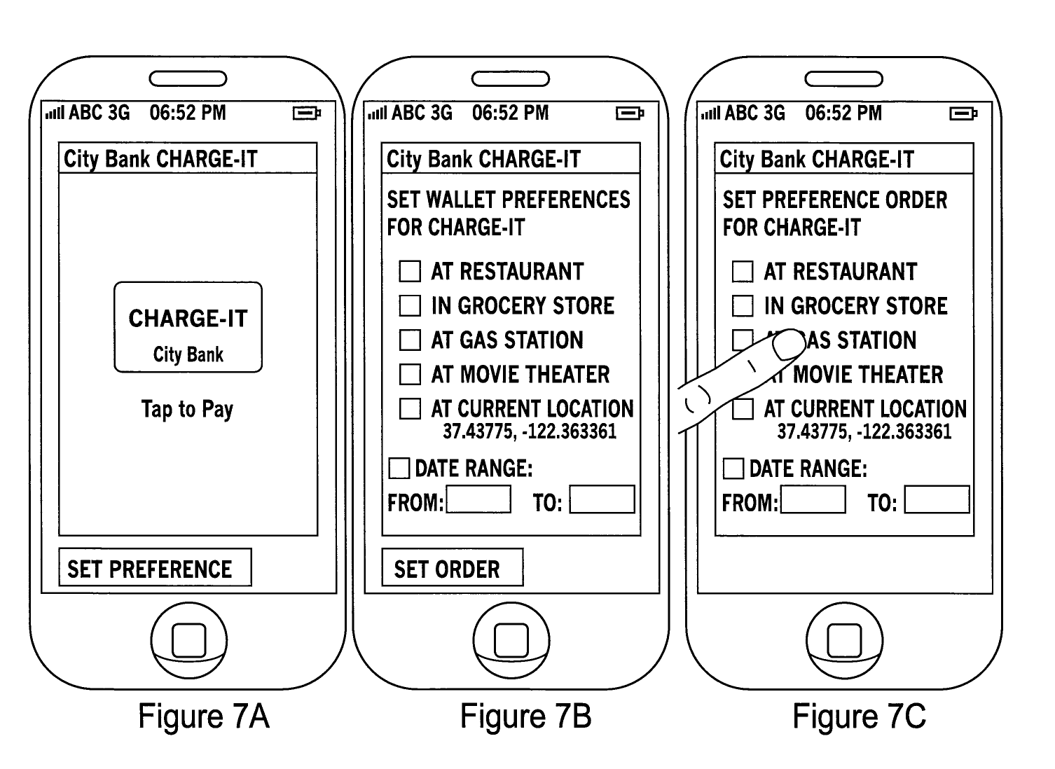

Now to illustrate one potential exemplary embodiment of user established preferences. Beginning with FIG. 6A, the user may set preferences for most credentials in their electronic wallet (the obvious exception being the event tickets discussed immediately above). For sake of illustration, let's say the user selects the “CHARGE-IT” credit card from City Bank. In the illustrated embodiment, another window pops-up on the user interface of the portable device shown in FIG. 7A, which provides the option to set preferences for the card selected from the main interface shown in FIG. 6A (it being understood that the same secondary screen providing for preference setting may be provided for each of the credentials depicted on the card window of the wallet. Upon selecting the “Set Preference” button, the window illustrated in FIG. 7B may be provided. In particular, this interface is illustrated as providing various categories of establishments at which users tend to use their credit and debit cards. As is now common place, some issuers try to entice credential holders by offering them incentives to use their credit/debit card in certain situations. For example, this month CHARGE-IT card by City Bank may be offering 5% cash back on all purchases at gas stations. Next month it may be 4% cash back at grocery stores. Another approach the issuers take is to provide loyalty points for certain transactions. Again here, the availability of those points may entice the wallet holder to select one card over another. Similarly, the user may prefer that a particular card be used within a given date range to take advantage of a longer billing cycle, or a date limited promotion. So, the user may select situations where the CHARGE-IT card should be used over the use of any other credential in the wallet. The ranking of those preferences may be changed. As depicted in FIG. 7C, in the exemplary user interface depicted in the figures, it would be possible to touch and drag each potential preference into a desired order with the highest priority on the top and the lowest on the bottom, for example. As illustrated, the user is about to change the priority of gas station preference for the CHARGE-IT card.

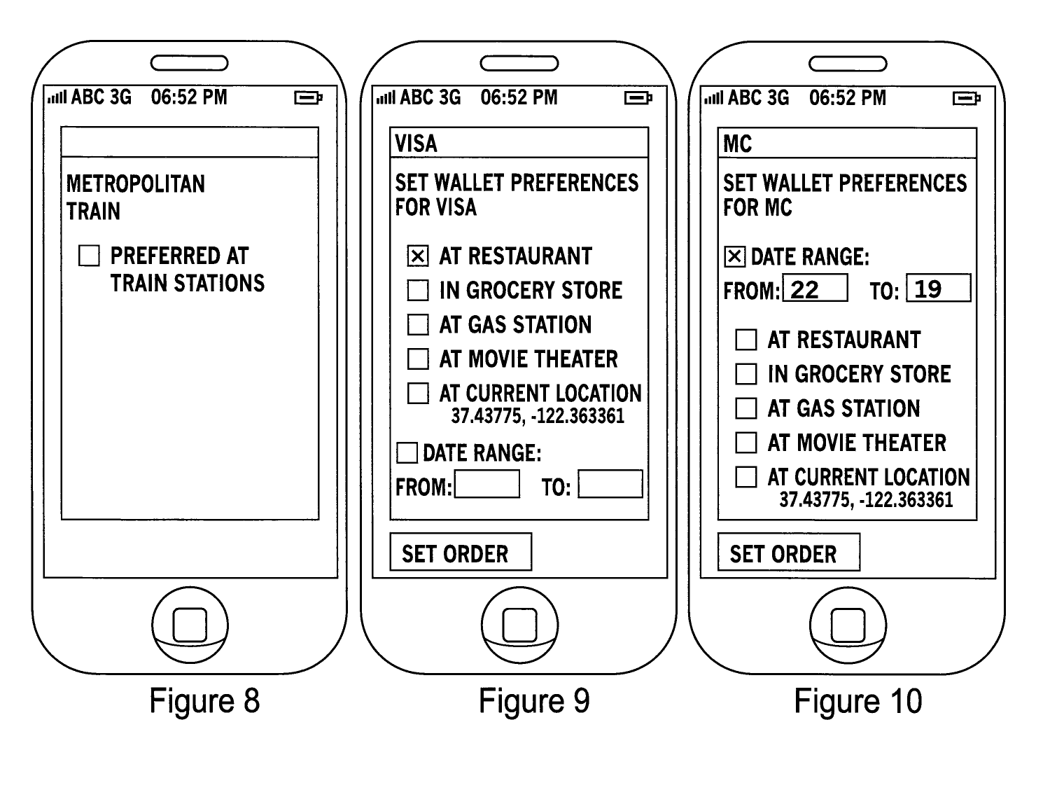

Some credentials may have limited preferences. For example, as shown in FIG. 8, a METROPOLITAN TRAIN credential cannot be used at gas stations, etc. It may be expected that those types of credentials will only be given the choice of designating the credential preferred where it makes logical sense. So, in the instance of Metropolitan Transit, the user may only be able to designated as a preference for the train station. One could imagine a similar limitation being used in association with store credit cards and other types of credentials.

In some situations, depending on the preferences selected for various cards, a conflict may arise. As illustrated in FIG. 9, a user may set their top preference for their “VISA” credit card credential as the preferred card at restaurants. Yet, as illustrated in FIG. 10, that same user may have also set the top preference for their “MC” credit card as a particular date range (e.g. the 22^{nd} of each month to the 19^{th} the next). If the user shakes portable communication device 50 in a restaurant on the 23^{rd} the month, the user would be notified of a preference conflict as shown in FIG. 11, and would be given an opportunity to select which card to use in the event of a conflict.

### Illustration of System Usage

To illustrate the system, a consumer may make several stops over the course of a day or several days where financial, purchase, or service transactions take place. The system of the invention simplifies this consumer's payment for goods or services, taking public transportation, and attending ticketed events. The exemplary consumer, Sally Shopper, may have a long list of errands and appointments over the course of several days. Having previously registered her wallet 100 and added her credentials (see FIGS. 6A-C), Sally Shopper may now configure those credentials prior to setting out. For example, as shown in FIG. 9, Sally may indicate a preference to use her Visa card to pay for meals at restaurants. Sally may also program in a preference for her City Bank CHARGE-IT card at supermarkets. Next, Sally may create a preference between one of her store credit cards—this one is for a place called “Hats Off”—and the geo-location of one of the store's location (which Sally may have found using Google maps). Sally may have also previously download her city's public transportation application 200 and associated that third party transit application with her wallet 100 so she can more easily pay for transit rides when she does not feel like driving.

Sally may also program her wallet to show preference to a credential based upon a date range (which would be compared against the date generated by the portable communication device). For example, the billing cycle on Sally Shopper's CHARGE-IT card may begin on the 20^{th} of each month. Thus, by adding a date range beginning on the 20^{th} of each month, Sally Shopper gains extra time in which to pay her bill. Finally, Sally may also store an event ticket credential for a night at the theater or a sporting event. These events have an inherent preference in that they occur on one specific date at a particular time at one specific venue all of which is inherently associated with the credential upon its creation.

Starting her day on October 20, Sally Shopper drives to her local Grocery Land market to purchase food and other household staples. Using the location identification service 400 (see FIG. 4), Sally's phone 50 is able to determine that it is located at a latitude and longitude that is associated with a supermarket so when Sally shakes her phone three times (see FIG. 1), the card services module 420 in cooperation with the secure payment subsystem moves Sally's CHARGE-IT card to the top of PPSE 121 in Sally's secure element 120, which, in turn, leads the phone 50 to emulate her CHARGE-IT credential via its NFC Baseband transmitter. The card reader will signal that the transaction is successful. The cashier provides Sally with a receipt and she exits the store.

As illustrated in FIG. 6C, the wallet can also contain coupons some of which may be useful at Grocery Land. As shown in the figure, the available coupons and their expiration dates are shown. As is well known to consumers, coupons should be redeemed prior to payment. The same is true with the present system: the coupon credentials should be emulated for the reader before the method of payment is emulated. As illustrated by FIG. 6C if a coupon is location-specific (i.e., must be used at a different store), it will appear as greyed out or have some other notation that the coupon is unavailable for use (as illustrated in FIG. 6C). Once a coupon is used it will preferably be deleted from a user's unique wallet. So, if Sally was purchasing a loaf of bread and some soda, she could select two relevant coupons from her wallet. The AIDs for those two coupons would be placed in the PPSE 121 ahead of the AID for Sally's CHARGE-IT card similar to the manner illustrated in FIG. 14.

After the grocery store, Sally may quickly drop her groceries at home so she can run to meet a friend for lunch at her favorite restaurant. Parking is difficult by the restaurant, so Sally heads to the nearest subway station and shakes her phone 50 as she approaches the turnstile. Comparing the phone's current geo-location to the locations stored in the transit map associated with the transit application 200 Sally downloaded to her phone, card service module 420 recognizes that Sally is in a Metropolitan Transit train station and places her train credential at the top of the PPSE 121 from which the train ticket credential is emulated by the secure payment subsystem 150 via the NFC Baseband and read by the turnstile—which is now in close physical proximity (i.e. on the order of a few centimeters) to the phone 50. Sally heads through the turnstile and boards her train.

After dining with her friend, the check arrives. Sally indicates to the waiter she wishes to pay by NFC transaction, so the waiter brings a hand-held NFC reader to Sally's table. Sally shakes her phone, in response to the resulting interrupt card services module 420 uses the location identification service 400 and a database of merchants (which may be stored remotely) to recognize that Sally is in a restaurant, review Sally's preprogrammed preferences (see FIG. 9), and in response to those preferences reorganize the PPSE 121 to place the credential for Sally's VISA® card at the top resulting in that credential being emulated by the NFC baseband. The reader collects the information, Sally adds a 25% tip (for exceptional service) on the portable reader, signs electronically on the reader, and the reader sends an electronic receipt of the transaction to Sally's phone.

Sally and her friend decide to visit their favorite boutique, Hats Off, to look for a fashionable hat and matching gloves for their trip to the theater later that day. Sally finds what she is looking for and brings it to the check-out desk. Sally shakes her phone and pays for her purchases with her Hats Off credit card. After saying good-bye to her friend at the store, Sally Shopper heads back to the train station, again paying at the turnstile and heading home.

That evening Sally plans to attend an 8:00 PM performance of South Pacific at Paramount Theatre. Arriving at Paramount Theatre at 7:00 PM, Sally again shakes her phone as she approaches the theater turnstile, as before card services module 420 recognizes the location generated by location identification service 400 and places the appropriate credential at the top of the PPSE. Had Sally gotten her show date and location mixed up (i.e. the ticket was for the next night or a different theatre), the wallet would not have recognized the inherent preference so it would not bring the South Pacific ticket credential to the top of the PPSE. Sally could then manually pull up the tickets in the wallet and note the mistake by looking at the information associated with the credential.

Sally may add or delete credentials from her wallet as the credential change and/or her preferences change. For instance, if her VISA® card changes it program so that the cash back bonus offered for restaurants is cancelled or alternatively another credential that Sally has offers her a higher cash back bonus then Sally may change her preferences. For purposes of further example, let's assume Sally adds a date range preference to her MASTERCARD® of the 22^{nd} of a first month to the 19^{th} of the next month. This preference will likely reflect the billing cycle of the card in such a way that it provides Sally with additional time to pay for things she buys. In this manner, even if Sally dines at her favorite restaurant for a second time later that week the wallet may behave differently. Here, a preference conflict arises, as illustrated in FIG. 11. Should the wallet use Sally's MASTERCARD® because it is the 23^{rd} of the month or should it use Sally's VISA® card so Sally can get the higher cashback bonus offered by her VISA® card at restaurants. Sally would then manual select one of the two methods of payment, the card services module 420 would place the selected credential at the top of the PPSE 121 for emulation.

Thus, Sally Shopper may use the inventive system for payment in a wide variety of situations with a wide variety of preferences. Shopping at a grocery store, dining, transportation, and attending events are all available. It would be understood by one of skill in the art that these are examples, and the invention is not limited by the range presented herein.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without deputing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for automatically emulating a preferred electronic credential from among a plurality of electronic credentials, the system being associated with a portable communication device having a geo-location identification service configured to detect a current geo-location of the portable communication device, the system comprising:
an interface for obtaining predetermined user preferences for the plurality of electronic credentials wherein at least some of the preferences relate to the geo-location of the portable communication device;
a processor configured to compare the current geo-location of the portable communication device with each of the predetermined user preferences and to select a preferred electronic credential from the plurality of electronic credentials; and
a secure element having a proximity payment system environment (PPSE), wherein each of the plurality of credentials are stored in the PPSE, wherein the processor further reorganizes the plurality of credentials such that the preferred electronic credential is placed in the PPSE to be emulated during a series of transactions.

2. The system according to claim 1 wherein the interface provides the ability to prioritize the predetermined user preferences.

3. The system according to claim 2 wherein the interface provides the ability to select between two or more electronic credentials from the plurality of electronic credentials when a preference conflict arises.

4. The system according to claim 3 wherein the portable communication device further includes a real-time service that indicates a current date and time, the processor further configured to compare the current date and time with each of the predetermined user preferences such that selection of the preferred electronic credential from the plurality of electronic credentials may be based in some part on the current date and time as well as the current geo-location of the portable communication device.

5. The system according to claim 4 wherein the interface displays one or more coupons, the processor further facilitating selection of one or more of the coupons and reorganizing the plurality of credentials such that the electronic credential associated with each selected one of the one or more coupons is placed in the PPSE to be emulated during a series of transactions.

6. The system according to claim 1 wherein the portable communication device further includes a real-time service that indicates a current date and time, the processor further configured to compare the current date and time with each of the predetermined user preferences such that selection of the preferred electronic credential from the plurality of electronic credentials may be based in some part on the current date and time as well as the current geo-location of the portable communication device.

7. The system according to claim 1 wherein the interface displays one or more coupons, the processor further facilitating selection of one or more of the coupons and reorganizing the plurality of credentials such that the electronic credential associated with each selected one of the one or more coupons is placed in the PPSE to be emulated during a series of transactions.
